(19) United States
(12) Patent Application Publication
(10) Pub. No.: US 2011/0194035 A1
(43) Pub. Date: Aug. 11, 2011

(54) IMAGE PROJECTION DEVICE

(76) Inventors: Jyunichi AIZAWA, Tokyo (JP); Kenichiro OKURA, Tokyo (JP)

(21) Appl. No.: 13/024,745

(22) Filed: Feb. 10, 2011

(30) Foreign Application Priority Data
Feb. 10, 2010 (JP) 2010-028187
Dec. 17, 2010 (JP) 2010-282272

(51) Int. Cl. H04N 9/31

(52) U.S. Cl. 348/744

(57) ABSTRACT

An image projection device that includes an optical projection system including: a projection lens arranged with an optical axis thereof shifted with respect to a light modulation device to project the light beam obliquely onto the screen; a flat mirror that reflects the light beam from the projection lens, has a rotation center on a side thereof on which a light beam having a long path from the projection lens to the screen is reflected, rotates around the rotation center and adjusts an angle of the light beam; and a curved mirror that reflects and magnifies the light beam from the flat mirror, has a rotation center on a side thereof on which a light beam having a short path from the projection lens to the screen is reflected, rotates around the rotation center and adjusts the angle of the light beam.

### BACKGROUND OF THE INVENTION

1. Field of the Invention

The present invention generally relates to an image projection device.

2. Description of the Related Art

In an image projection device such as a projector and a projection television that enlarges and projects an image onto a screen, a high degree of positional precision is required for a curved mirror that enlarges the image. For this reason, if dimensional deviation occurs in the shapes of the curved mirror and other optical components, or if these components are misaligned from the normal fixation positions even in the slightest terms, the image projected on the screen may be shifted or trapezoidal distortion may occur to the image.

In a conventional mirror adjusting mechanism, an optical projection unit is provided with an optical path bending unit that reflects an optical image signal from an optical refraction unit to a reflecting unit. The optical refractive unit is designed in such a manner that the direction of an optical axis thereof can be bent at an appropriate angle on a horizontal plane that includes the optical axis of the reflecting unit. In addition, a mirror adjusting mechanism has been known that is provided with an optical refractive unit and a reflecting unit configured to be rotationally symmetrical structures with a shared optical axis. This mechanism further includes a convex unit in the vicinity of the optical axis, a V-shaped support that fits the convex unit into its V-shaped groove, two springs with their ends fixed to the left and right sides of the convex unit to give tension to the reflecting unit, a second screwing unit provided on a side other than the bottom side of a rectangle and held slidably with respect to a second reflecting-unit mounting mechanism, and a third screwing unit provided on a side other than the bottom side of the rectangle and held slidably with respect to a third reflecting-unit mounting mechanism (see, for example, paragraphs 0026, 0029, and 0072 and FIGS. 23 and 73 of Japanese Patent Application Laid-open No. 2002-207168).

Another example that has been known is a structure provided with a free-form curved mirror in which the curvature of the portion that reflects light traveling toward the bottom of the screen is greater than the curvature of the portion that reflects light traveling toward the top of the screen, or in which the portion that reflects the light traveling toward the bottom of the screen is convexed in the light reflection direction and the portion that reflects the light traveling toward the top of the screen is concaved, and a mechanism for rotating this free-form curved mirror by using substantially the center of the free-form curved mirror as the central axis (see, for example, paragraphs 0011 and 0012, and FIGS. 3 and 8 of Japanese Patent Application Laid-open No. 2006-292900).

Still another example that has been known is a structure provided with a correcting unit that corrects an image by adjusting light from the projection engine unit, and also with a driving mechanism for at least either moving or rotating the projection engine unit (see, for example, paragraphs 0010 and 0011, FIGS. 3 and 9 of Japanese Patent Application Laid-open No. 2008-70694).

The mirror adjusting mechanism according to Japanese Patent Application Laid-open No. 2002-207168 and the like is provided with a mechanism for adjusting the angle of the curved mirror, but no mechanism is arranged for the flat mirror that reflects the light beam travelling from the projection lens to the curved mirror. For this reason, although distortion of the projected image and shift of the projected image for a greater optical length (longer path of the light beam) can be corrected, shift of the projected image for a shorter optical length remains uncorrected.

Furthermore, the mirror adjusting mechanism according to Japanese Patent Application Laid-open No. 2006-292900 and the like can adjust the angle of the curved mirror. However, it only turns backward and forward, and thus it cannot control the distortion separately for the left and right portions of the projected image. In addition, a flat mirror is arranged between the curved mirror and the screen, but the shift of the projected image cannot be fully corrected because there is not an angle adjusting mechanism.

Still further, in the mirror adjusting mechanism according to Japanese Patent Application Laid-open No. 2008-70694 and the like, the structure in which a flat mirror is arranged between the projection lens and the curved mirror is the same, but no adjusting mechanism is provided for these mirrors. Because the projected image adjustment is conducted by rotating or moving the engine itself, the correction cannot be accurately or elaborately performed.

### SUMMARY OF THE INVENTION

It is an object of the present invention to at least partially solve the problems in the conventional technology.

According to an aspect of the present invention, there is provided an image projection device, including: an optical illumination system that includes a light source; a light modulation device that receives an image signal, and modulates a light beam emitted from the optical illumination system in accordance with the image signal; and an optical projection system that magnifies and projects modulated light received from the light modulation device onto a screen for displaying an image, wherein the optical projection system includes: a projection lens that is arranged with an optical axis thereof shifted with respect to the light modulation device in order to project the light beam obliquely onto the screen, and magnifies and projects the modulated light received from the light modulation device; a flat mirror that reflects the light beam output from the projection lens, has a rotation center on a side thereof on which a light beam having a long path from the projection lens to the screen is reflected, rotates around the rotation center and adjusts an angle of the light beam; and a curved mirror that reflects and magnifies the light beam received from the flat mirror, has a rotation center on a side thereof on which a light beam having a short path from the projection lens to the screen is reflected, rotates around the rotation center and adjusts the angle of the light beam.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a sectional view of an optical projection system including a mirror adjusting mechanism according to the first embodiment;

FIG. 2 is a perspective view of the optical projection system that includes the mirror adjusting mechanism according to the first embodiment;

FIG. 3 is a side view for showing the path of a light beam projected from the optical projection system including the mirror adjusting mechanism according to the first embodiment;

FIG. 4 is an exploded view of a flat mirror adjusting mechanism according to the first embodiment;

FIG. 5 is a sectional view of a supporting portion for the rotation axis of the flat mirror adjusting mechanism according to the first embodiment;

FIG. 6 is a sectional view of the flat mirror adjusting mechanism according to the first embodiment;

FIG. 7 is a perspective view of the curved mirror adjusting mechanism according to the first embodiment;

FIG. 8 is an exploded view of the curved mirror adjusting mechanism according to the first embodiment;

FIG. 9 is a partial sectional view of the curved mirror adjusting mechanism according to the first embodiment;

FIG. 10 is a partial sectional view of the curved mirror adjusting mechanism according to the first embodiment;

FIG. 11 is a side view of the curved mirror according to the first embodiment;

FIG. 12 is a diagram explaining a state of the projected image corrected by the curved mirror according to the first embodiment;

FIG. 13 is a diagram explaining a state of the projected image corrected by the curved mirror according to the first embodiment;

FIG. 14 is a diagram explaining a state of the projected image corrected by the flat mirror according to the first embodiment;

FIG. 15 is a diagram explaining a state of the projected image re-corrected by the curved mirror according to the first embodiment;

FIG. 16 is a diagram explaining a state of the projected image corrected by the flat mirror according to the first embodiment;

FIG. 17 is a diagram explaining a state of the projected image re-corrected by the curved mirror according to the first embodiment;

FIG. 18 is a diagram showing the structure of an image projection device according to the second embodiment; and

FIG. 19 is a diagram showing the structure of an image projection device according to the third embodiment.

### DETAILED DESCRIPTION OF THE PREFERRED EMBODIMENTS

### First Embodiment

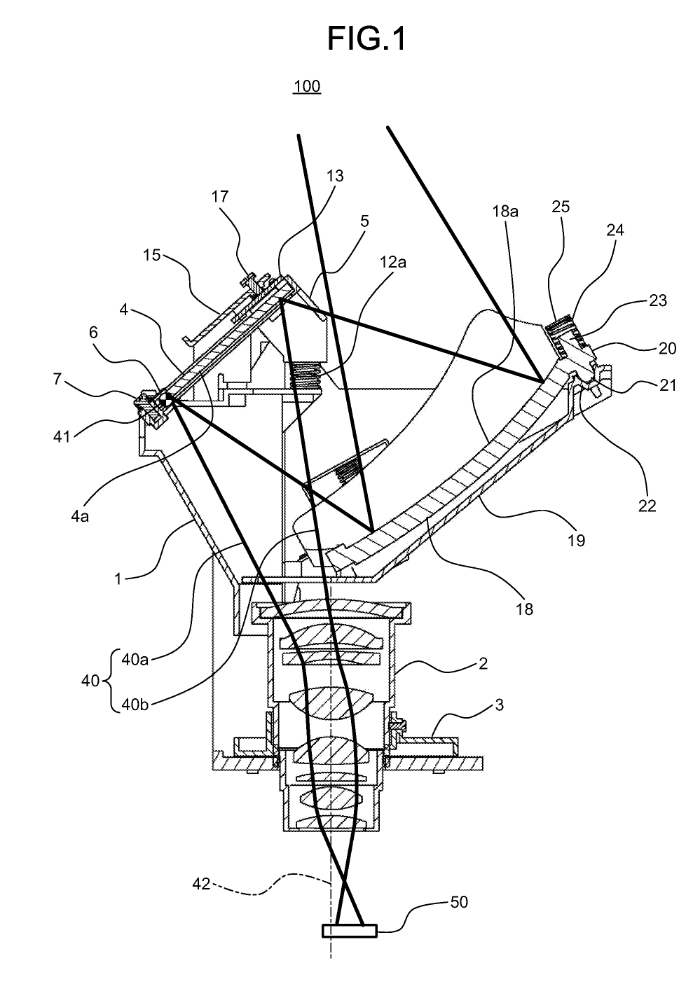

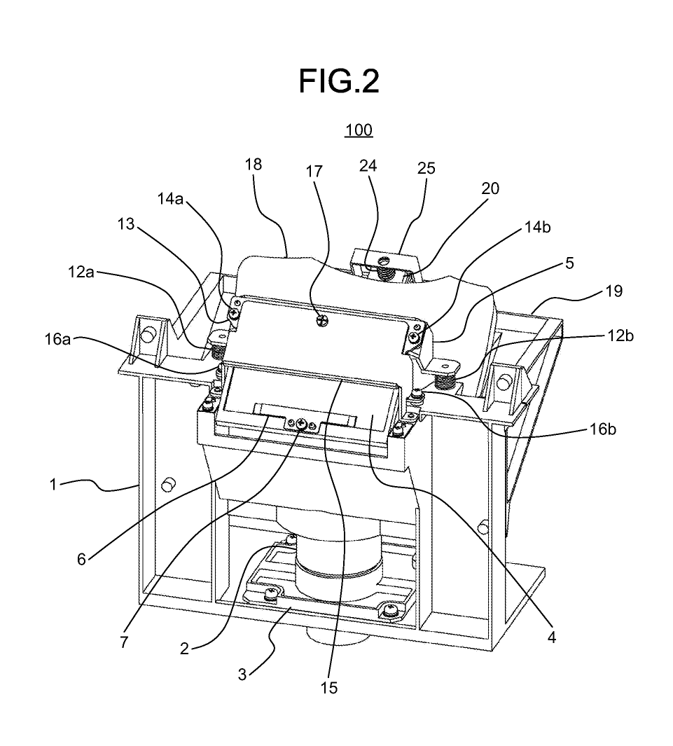

The mirror adjusting mechanism according to the first embodiment is explained below with reference to the drawings. FIG. 1 is a sectional view for showing an optical projection system 100 that includes the mirror adjusting mechanism according to the present embodiment, and FIG. 2 is a perspective view thereof. As illustrated in FIGS. 1 and 2, the optical projection system 100 includes a base member 1 that holds the components; a projection lens 2 that magnifies a light beam 40; a flange 3 that holds the projection lens 2 and is fixed to the base member 1; a flat mirror 4 that reflects the light beam 40 coming from the projection lens 2 and changes its direction; a holder for the flat mirror 5 that serves as a supporting unit for the flat mirror 4; a rotation axis 41 that serves as a central axis for the rotation of the holder for the flat mirror 5; a plate spring 6 that urges the flat mirror 4 toward the holder for the flat mirror 5; a screw 7 that fastens the plate spring 6; coil springs (elastic members) 12a and 12b sandwiched between the base member 1 and the holder for the flat mirror 5 to urge the holder for the flat mirror 5 upward; a plate 13 bridging on the top surface of the holder for the flat mirror 5; screws 14a and 14b that fasten the plate 13 onto the holder for the flat mirror 5; a stopper 15 arranged so as to cover the top portion of the holder for the flat mirror 5; screws 16a and 16b that fasten the left and right ends of the stopper 15 to the base member 1; an adjustment screw 17 that is fitted into a screw hole in the stopper 15 and has a hemispherical tip brought into contact with the plate 13; a curved mirror 18 that reflects the light beam 40 coming from the flat mirror 4 and further magnifies it; a holder for the curved mirror 19 that holds the curved mirror 18; a supporting portion 20 arranged in the center of the end portion of the curved mirror 18; a protrusion 21 (first spherical protrusion) having a hemispherical tip and protruding from the supporting portion 20 toward the holder for the curved mirror 19; a receiver 22 that is arranged in the holder for the curved mirror 19 and has a cone-shaped surface with which the tip of the protrusion 21 is brought into contact; a boss (third protrusion) 23 on the opposite side with respect to the protrusion 21; a coil spring (elastic member) 24 fitted to the boss 23 and brought into contact with the top surface of the supporting portion 20; a retaining member 25 that retains the other end of the coil spring 24; and a reflective light modulating device 50 arranged at a position shifted from an optical axis 42 of the projection lens 2.

The reflective light modulating device 50 may be a reflective light modulating device such as a digital micro-mirror device (DMD) configured by aligning in one plane a multitude (hundreds of thousands, for example) of movable micro-mirrors corresponding to respective pixels so that the tilt angles of the micro-mirrors can be changed in accordance with the pixel information. The structure in front of the reflective light modulating device 50 in the light traveling direction is referred to as an optical illumination system, while the structure behind the reflective light modulating device 50 in the light traveling direction is referred to as an optical projection system. The reflective light modulating device 50 may be included in either the optical illumination system or the optical projection system.

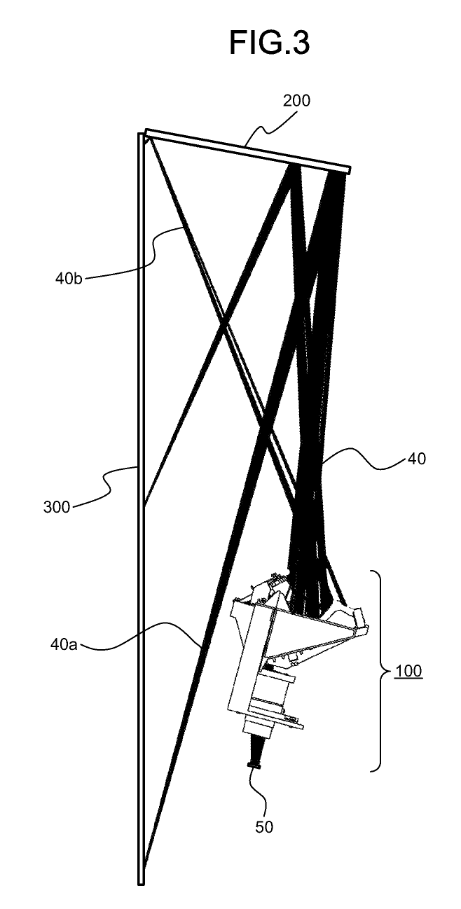

Next, the path of the light beam 40 in the optical projection system 100 is explained. In FIG. 1, the light beam 40 that is emitted from the not shown optical illumination system and reflected from the reflective light modulating device 50 is incident in a slanting direction onto the inlet of the projection lens 2. The light beam 40 from the projection lens 2 is output in a slanting direction with respect to the optical axis 42, and reflected from a reflection surface 4a of the flat mirror 4 so as to return in an obliquely downward direction. The light beam 40 is further reflected from a reflection surface 18a of the curved mirror 18, passes on the side of the holder for the flat mirror 5 avoiding interference thereof, and travels upward. FIG. 3 is a diagram showing the path of the light beam 40 projected from the optical projection system 100. The light beams 40 reflected from the curved mirror 18 cross when traveling upward, and spread further upward after crossing. Then, the light beam 40 is reflected from a top panel mirror 200 arranged on the ceiling of the device, and projected on the back surface of a screen 300 to present an image. According to the present embodiment, the flat mirror 4 is tilted down to bend the light beam 40 in a vertical direction. Alternatively, the flat mirror 4 held in a vertical direction may be rotated in a horizontal direction so that the light beam 40 can be bent in a horizontal direction.

For convenience of explanation, the left side of FIGS. 1 and 3, or in other words, the side on which the screen 300 is arranged, is defined as the front side of the optical projection system 100, and the right side is defined as the rear side of the optical projection system 100. A light beam 40a that is the front side of the light beam 40 emitted from the projection lens 2 is reflected on the anterior sides of the flat mirror 4 and the curved mirror 18. The front-side light beam 40a that is traveling upward crosses a rear-side light beam 40b and is reflected on the rear side of the top panel mirror 200 and projected onto the bottom edge of the screen 300. In addition, the rear-side light beam 40b of the light beam 40 emitted from the projection lens 2 is reflected on the rear sides of the flat mirror 4 and the curved mirror 18, then reflected on the front side of the top panel mirror 200, and projected onto the upper end of the screen 300.

According to the present embodiment, the optical axis of the projection lens 2 is shifted toward the front with respect to the reflective light modulating device 50 so that the light beam 40 is casted obliquely onto the screen 300. As a result, the path, or optical length, of the front-side light beam 40a from the projection lens 2 to the screen 300 becomes longer than the optical length of the rear-side light beam 40b. Furthermore, the light beam 40a with a greater optical length forms a greater light incident angle with respect to the screen 300 than the light beam 40b with a smaller optical length. A greater light incident angle means that the light beam is incident more obliquely onto the screen 300, and thus the shift amount on the screen is large when the angle of the light beam is inaccurate. In other words, the sensitivity of the projected image shift in association with changes of the light beam angle from the reflection surface 18a of the curved mirror 18 is greater for the light beam 40a than for the light beam 40b.

The light beam 40a that is reflected from the front side of the curved mirror 18 is sensitive to changes in the angle with respect to the reflection surface 18a, while the light beam 40b that is reflected from the rear side is less sensitive. For this reason, if the reflection surface 18a of the curved mirror 18 is not formed with high profile accuracy and thus causes an error in the angle of the reflection surface 18a, or if the angle of the top panel mirror 200 or the screen 300 is deviated from the design value, the bottom end of the image on the screen 300 where the light beam 40a reflected on the front side of the curved mirror 18 is projected is significantly shifted. On the other hand, the position of the top end of the image on the screen 300 where the light beam 40b reflected on the rear side of the curved mirror 18 is projected is shifted less. To correct the shift of the bottom end of the image projected on the screen 300, the angle of the light beam 40a is preferably changed with a minimum change in the angle of the light beam 40b. Hence, the protrusion 21 having a hemispherical tip is arranged at the center of the low-sensitivity rear side of the curved mirror 18, and the curved mirror 18 is pivotally supported (to be rotatable in all surrounding directions) by using the center of the hemisphere as a pivot so that the angle of the curved mirror 18 can be adjusted.

By designing the curved mirror 18 to be rotatable around its rear side, the front side of the curved mirror 18 changes its height when the curved mirror 18 is rotated. In accordance with a change in height, the reflection position of the light beam 40a on the reflection surface 18a changes. Because the reflection surface 18a of the curved mirror 18 is curved, the reflection angle changes in accordance with a change in the reflection position. For example, if the curved mirror 18 rotates clockwise in FIG. 1, the reflection position of the light beam 40a is shifted toward the front, and thus the light beam 40a is tilted to the right. In addition to a change in the angle of the curved mirror 18 itself, the light beam 40a tilts further to the right in accordance with a change in the reflection position. On the other hand, because the rear side of the curved mirror 18 is close to the rotation center, the height changes very little. With little change in height, the reflection position of the light beam 40b reflecting from the reflection surface 18a does not change, but only the angle from the reflection surface 18a changes. Thus, the amount of change in angle is small. In other words, when the angle of the curved mirror 18 is changed, the angle of the light beam 40a significantly changes, which significantly moves the position of the bottom end of the image projected on the screen 300. On the other hand, the angle of the light beam 40b here changes little, which barely moves the upper end of the image projected on the screen 300. In this manner, the shift of the bottom end of the image projected on the screen 300 can be corrected.

However, when the top end of the image projected on the screen 300 is shifted because of the displacement of the reflective light modulating device 50 in the in-plane direction, the displacement of the optical axis 42 of the projection lens 2, or the displacement of the rotation center of the curved mirror 18, the shift of the image projected cannot be fully corrected simply by adjusting the angle of the curved mirror 18. For this reason, the flat mirror 4 is also designed to make its angle adjustable, and thereby the position of the top end of the image projected on the screen 300 can be corrected. The curved mirror 18 is provided with a rotation center at its rear side to correct the position of the bottom end of the image projected on the screen 300. In contrast to the curved mirror 18, the flat mirror 4 is provided with the rotation axis 41 on its front side to correct the top end of the image projected on the screen 300. Incidentally, if the rotation axis of the flat mirror 4 is provided on its rear side to make the front side rotatable in a similar manner to the curved mirror 18, the top end of the image projected on the screen 300 would barely move.

Unlike the curved mirror 18, the flat mirror 4 is not meant to magnify the light beam 40, and thus the position of the top end of the image projected on the screen 300 is not largely changed by arranging the rotation axis 41 on the front side of the flat mirror 4. However, the position of the projected image can be changed more than with the arrangement of the rotation axis on the rear side of the flat mirror 4. Furthermore, the angle of the light beam 40 incident on the curved mirror 18 is changed by adjusting the angle of the flat mirror 4. The position of the image projected on the screen 300 is moved not only on the top end but also on the bottom end, but in such a case, the angle of the curved mirror 18 can be readjusted to correct the position of the bottom end of the projected image.

As described above, the rotation center of the curved mirror 18 is provided on its low-sensitivity rear side, or in other words, on the side with a smaller optical length to the screen 300. Thus, when the image projected on the bottom end side of the screen 300 is shifted, the projected image position can be corrected by adjusting the angle of the curved mirror 18. Moreover, the rotation axis 41 of the flat mirror 4 is provided on its front side, and thus when the image projected on the top end of the screen 300 is shifted, the projected image position can be corrected by adjusting the angle of the flat mirror 4.

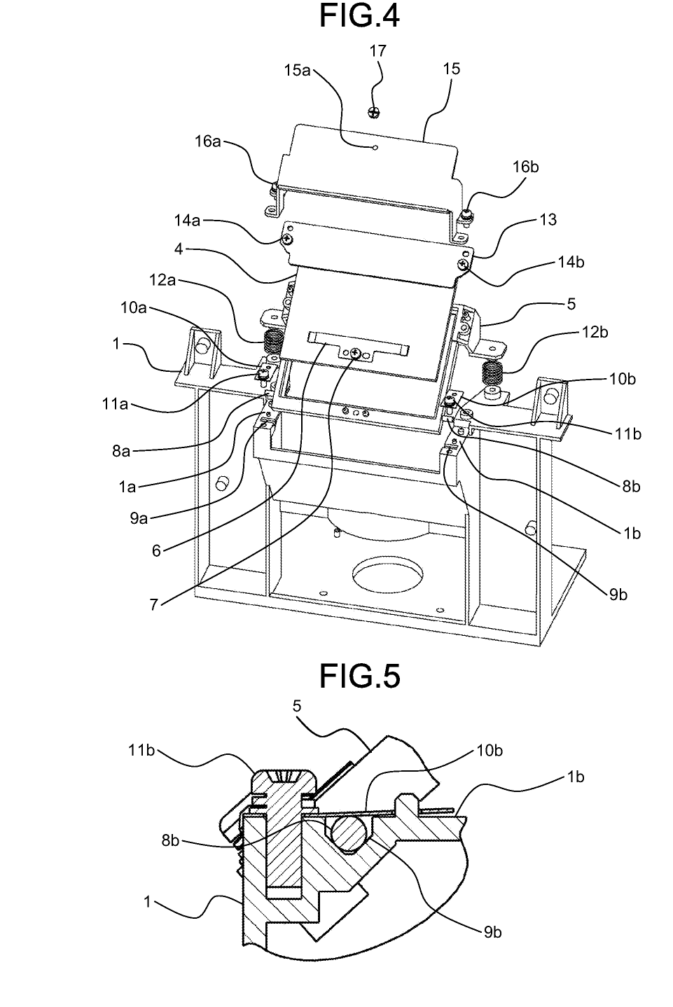

Next, the specific structure of the adjusting mechanism of the flat mirror 4 is explained. FIG. 4 is an exploded view of the adjusting mechanism of the flat mirror 4, in which the flat mirror 4 is positioned with its reflection surface 4a facing down onto the holder for the flat mirror 5 and supported with the plate spring 6 pressing the flat mirror 4 down from its top. The plate spring 6 is fixed to the holder for the flat mirror 5 by the screw 7. On the two side surfaces of the holder for the flat mirror 5, two cylindrical bosses (first and second protrusions) 8a and 8b are concentrically formed to serve as a rotation axis, and fitted into V-shaped grooves 9a and 9b provided in the base member 1. The bosses 8a and 8b are pressed down by plate springs (elastic member) 10a and 10b from above and rotatably supported with the plate springs 10a and 10b fixed onto mounting surfaces 1a and 1b of the base member 1 by screws 11a and 11b. FIG. 5 is a partially enlarged sectional view of the supporting portion of the boss 8b, where the boss 8b is fitted into the V-shaped groove 9b, and pressed down by the plate spring 10b from above. The boss 8b is designed to have part of its circumference slightly protruding from the mounting surface 1b of the base member 1, and thus when fixing the plate spring 10b by the screw 11b, the plate spring 10b is bowed to press the boss 8b into the V-shaped groove 9b. The boss 8a on the other side is supported by a similar supporting structure.

Because the coil springs 12a and 12b are interposed and pressed between the base member 1 and the holder for the flat mirror 5 at the time of assembly, pressing force that rotates the holder for the flat mirror 5 upwardly is exerted. To control the rotation range of the holder for the flat mirror 5, the plate 13 is fixed onto the top surface of the holder for the flat mirror 5 by the screws 14a and 14b, and the stopper 15 is fixed to the base member 1 by the screws 16a and 16b so as to cover the plate 13. A screw hole 15a is provided in the stopper 15, through which the hemispherical tip of the adjustment screw 17 is brought into contact with the plate 13.

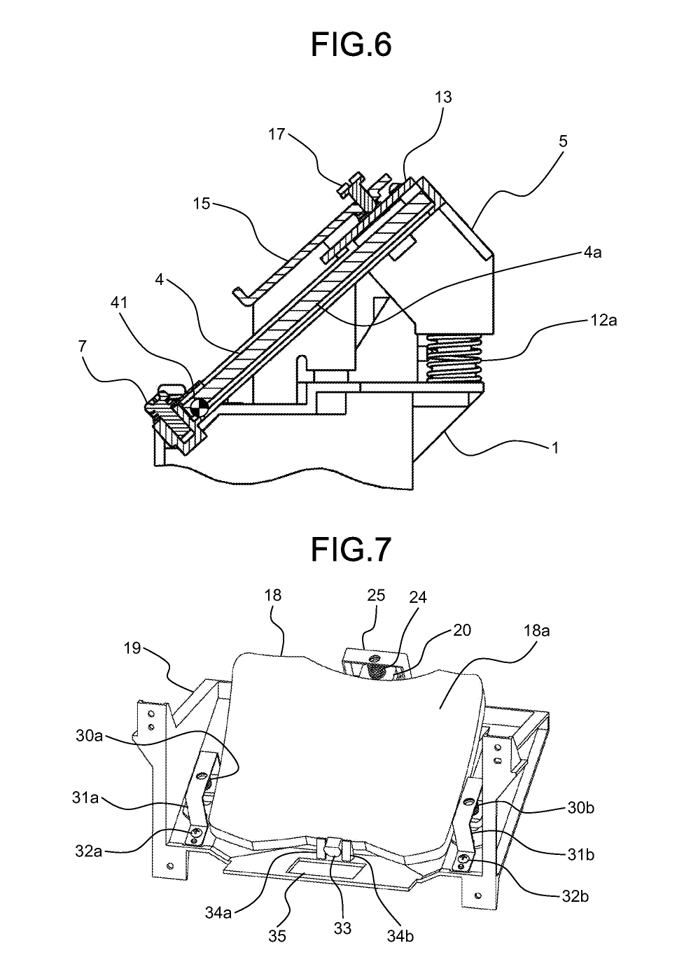

Next, the operation of the adjusting mechanism of the flat mirror 4 is explained. FIG. 6 is a sectional view for presenting an enlarged view of the adjusting mechanism of the flat mirror 4, in which the holder for the flat mirror 5 tries to rotate counterclockwise around the rotation axis 41 formed by the bosses 8a and 8b under the spring force of the coil spring 12a (12b is not shown) that is sandwiched between the holder for the flat mirror 5 and the base member 1. On the other hand, the tip of the adjustment screw 17 mounted in the stopper 15 is brought into contact with the plate 13 so that it controls the movement of the holder for the flat mirror 5. Under this condition, the holder for the flat mirror 5 is rotated by turning the adjustment screw 17 around, and thereby the angle of the flat mirror 4 supported by the holder for the flat mirror 5 is adjusted.

As described above, the bosses 8a and 8b are received by the V-shaped grooves 9a and 9b, and thus the holder for the flat mirror 5 can be reliably rotated without displacement of the rotation axis 41. Furthermore, because the freedom of the angular adjustment is limited to one axis, the structure of the adjusting mechanism is simplified, which can reduce the cost. Furthermore, because a flat mirror is adopted and thus the reflection angle of the light beam does not change even when the mirror is displaced in an in-plane direction, and thus the image projected on the screen would not be shifted. In addition, the coil springs 12a and 12b are arranged on the left and right ends of the holder for the flat mirror 5, and thus are prevented from interfering the light beam 40 incident onto the flat mirror 4 or the reflected light beam 40 travelling to the curved mirror 18. Furthermore, the holder for the flat mirror 5 is urged in the rotational direction by the coil springs 12a and 12b and brought into contact with the adjustment screw 17 to control the position. Thus, the angle can be smoothly and elaborately adjusted, and because the holder for the flat mirror 5 is always urged by the coil springs 12a and 12b, the position of the holder for the flat mirror 5 does not have to be fixed by any other method after the adjustment.

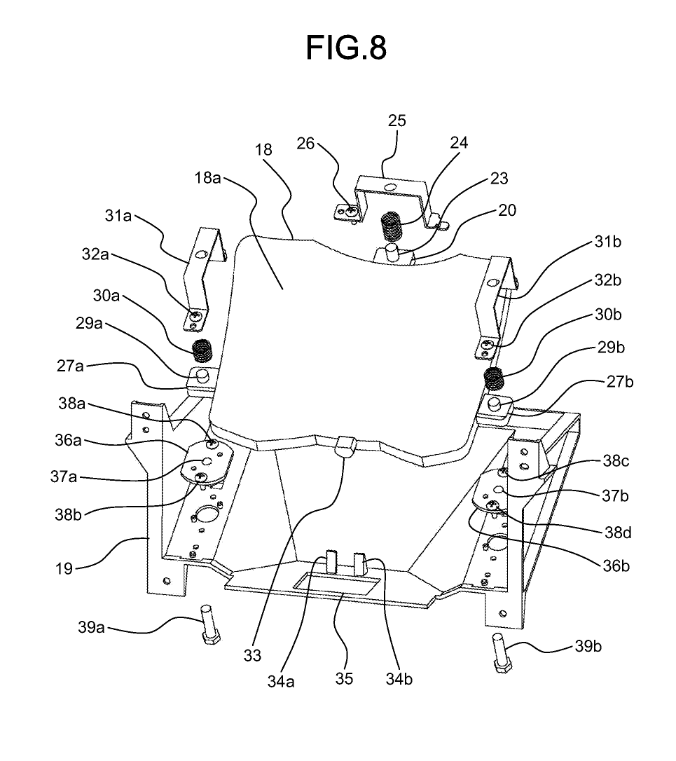

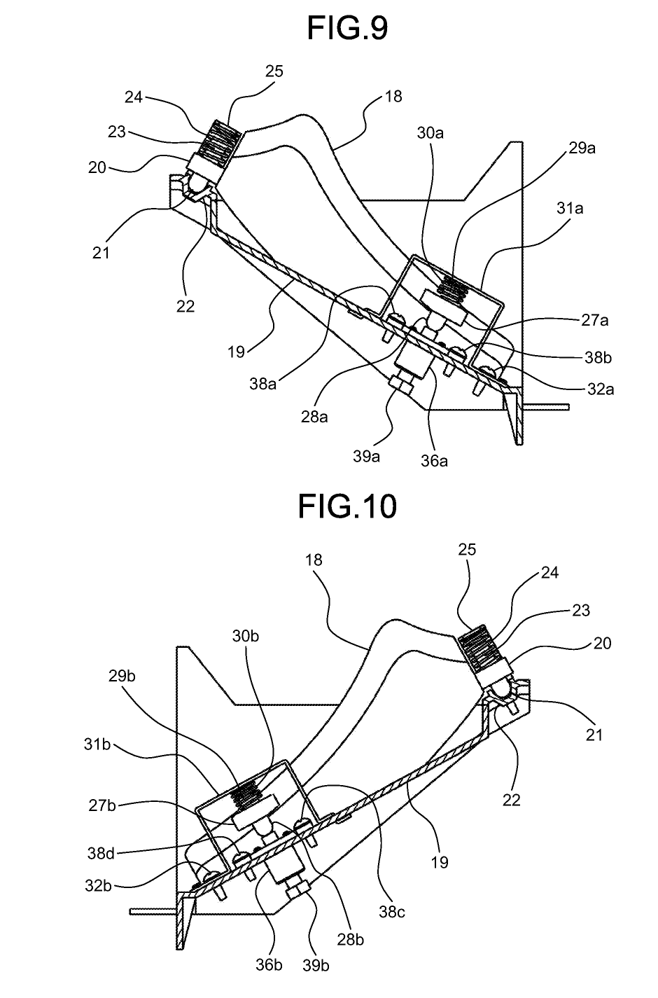

Next, the specific structure of the adjusting mechanism of the curved mirror 18 is explained. FIG. 7 is a perspective view of the adjusting mechanism of the curved mirror 18, and FIG. 8 is an exploded view thereof. FIG. 9 is a partial sectional view for showing a section of the holder for the curved mirror 19, and FIG. 10 is a partial sectional view of the structure viewed from the opposite side. As illustrated in FIG. 8, four projecting portions are formed in the rim of the curved mirror 18. The supporting portion 20 arranged in the center of the top portion of the curved mirror 18 and supporting portions 27a and 27b arranged on the opposed positions on the left and right sides thereof are designed to support the curved mirror 18. The boss 23 (third protrusion) and bosses (fourth and fifth protrusions) 29a and 29b are provided on the top surfaces of the corresponding units. Furthermore, as illustrated in FIGS. 9 and 10, the protrusion (first spherical protrusion) 21 with a hemispherical tip portion is formed on the bottom surface of the supporting portion 20, and similarly, a protrusion (second spherical protrusion) 28a and a protrusion (third spherical protrusion) 28b also with hemispherical tip portions are formed on the bottom surfaces of the supporting portion 27a and the supporting portion 27b, respectively. Furthermore, a positioning boss (sixth protrusion) 33 is provided at the center of the bottom portion of the curved mirror 18.

On the other hand, in the holder for the curved mirror 19, bushes 36a and 36b, in the respective centers of which screw holes 37a and 37b are formed, are fixed by screws 38a and 38b and screws 38c and 38d, respectively. Adjustment screws 39a and 39b are screwed into the bushes 36a and 36b from the back of the holder for the curved mirror 19. Moreover, guides 34a and 34b between which the positioning boss 33 is fitted and a window 35 through which the light beam 40 passes from the projection lens 2 are provided in the bottom of the holder for the curved mirror 19. The inner surfaces of the guides 34a and 34b are parallel to each other so that they leave no space between the outer diameter of the boss 33 and themselves. The normal distance between the boss 33 and the bottom of the holder for the curved mirror 19 and the length of the guides 34a and 34b is adjusted such that when the curved mirror 18 moves, the boss 33 would not touch the bottom of the holder for the curved mirror 19 and would not protrude from the guides 34a and 34b.

In assembly, first, the curved mirror 18 is mounted on the holder for the curved mirror 19. At this point, the protrusion 21 of the curved mirror 18 is brought into contact with the receiver 22 of the holder for the curved mirror 19, and the positioning boss 33 is inserted between the guides 34a and 34b. In this manner, the position of the curved mirror 18 is determined, and the left and right protrusions 28a and 28b of the curved mirror 18 are automatically brought into contact with the tips of the adjustment screws 39a and 39b, respectively. Next, the coil spring 24 is fitted onto the boss 23, and fixed onto the holder for the curved mirror 19 by a screw 26 while pressing the coil spring 24 with the retaining member 25. Then, the hemispherical tip of the protrusion 21 is pressed against the cone-shaped surface of the receiver 22, thereby forming a pivot mechanism that can pivot around the center of the hemispherical protrusion 21 (i.e., rotate in all surrounding directions). Furthermore, the distance between the tip of the boss 23 and the retaining member 25 in the pivot mechanism, is configured to be shorter than the length of the portion of the protrusion 21 inserted into the receiver 22 of the holder for the curved mirror 19. Then, in the same manner as the pivot mechanism, coil springs (elastic member) 30a and 30b are fitted into the bosses 29a and 29b and fixed with screws 32a and 32b by pressing then down with retaining members 31a and 31b. In this manner, an adjusting mechanism for adjusting the angle of the curved mirror 18 is formed.

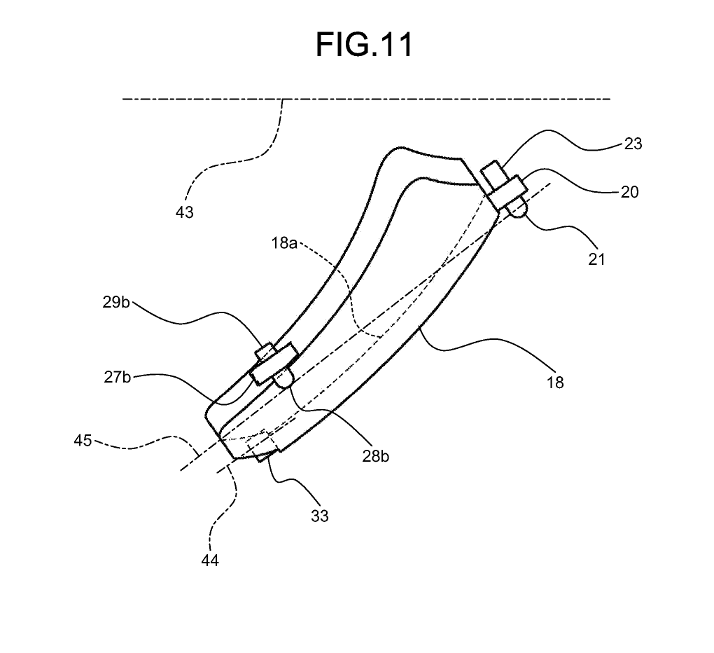

FIG. 11 is a side view of the curved mirror 18 according to the present embodiment, in which the reflection surface 18a is rotationally symmetrical around an optical axis 43 that runs coaxially with respect to the optical axis 42 of the projection lens 2. Furthermore, the boss 33 is a cylinder whose circumference is partially cut off along the axis (having a cylindrically curved surface 180 degrees or greater in the circumferential direction), and is arranged in such a manner that a center axis 44 runs substantially parallel to a rotation axis (the line running through the pivot of the protrusion 21) 45 at the time of adjusting the angle of the curved mirror 18. Here, a straight line formed by the intersection of a plane, which is brought into contact with the hemispherical tips of the protrusion 28b and the not-shown protrusion 28a and runs through the center (pivot) of the protrusion 21, and a plane, which expands in a direction perpendicular to this plane in a manner to divide the curved mirror 18 at its center, becomes the rotation axis 45 at the time of adjusting the angle of the curved mirror 18. When the angle of the curved mirror 18 is adjusted and changed, the angle of the rotation axis 45 is also slightly changed. Thus, the center axis 44 of the boss 33 cannot always be agreed with the rotation axis 45 of the curved mirror 18.

Next, the operation of the adjusting mechanism of the curved mirror 18 is explained. In FIGS. 9 and 10, the pivot mechanism of the curved mirror 18 is rotatably supported with the center of the protrusion 21 serving as the rotation center. Furthermore, in the adjusting mechanism on the left and right of the curved mirror 18, the tips of the protrusions 28a and 28b are brought into contact with the flat tips of the adjustment screws 39a and 39b, respectively. This means that the curved mirror 18 is supported at three points by three protrusions, the protrusion 21 and the protrusions 28a and 28b. By rotating the adjustment screws 39a and 39b and separately changing the heights of the left and right sides of the curved mirror 18 in this structure, the angle of the curved mirror 18 can be adjusted as desired. Furthermore, because the boss 33 is restricted by the guides 34a and 34b in its width direction, the curved mirror 18 is prevented from rotating around the protrusion 21 in this direction.

Because the curved mirror 18 is supported at three points by the three protrusions 21, 28a, and 28b, the curved mirror 18 is prevented from wobbling and is reliably supported when it is mounted. Moreover, the bosses 23, 29a, and 29b are arranged on the opposite side with respect to the three protrusions 21, 28a, and 28b, and the coil springs 24, 30a and 30b are fitted thereon and pressed down by the retaining members 25, 31a, and 31b. Thus, the curved mirror 18 is prevented from being detached in any direction it is placed. Then, the pivot mechanism is configured by bringing the hemispherical tip of the protrusion 21 of the curved mirror 18 into contact with the cone-shaped receiver 22 of the holder for the curved mirror 19. In particular, by bringing the hemispherical tip of the protrusion 21 into contact with the cone-shaped receiver 22, the curved mirror 18 is supported pivotally around the protrusion 21. In this manner, the curved mirror 18 can be supported so as to rotate around the protrusion 21 in all surrounding directions. In addition, because the rotation center of the curved mirror 18 serves as a reference position and is prevented from being displaced, optical performance such as resolution and image quality can be ensured.

In addition, the distance between the tip of the boss 23 and the retaining member 25 in the pivot mechanism is designed to be shorter than the length of a portion of the protrusion 21 inserted into the receiver 22 of the holder for the curved mirror 19. In other words, the length of a stroke formed by the boss 23 of the pivot mechanism moving back and forth is smaller than the length of the portion of the protrusion 21 inserted into the receiver 22 of the holder for the curved mirror 19. For this reason, even when the curved mirror 18 is jumped up on impact or the like, the protrusion 21 would not come off the receiver 22 because the boss 23 is in contact with the retaining member 25, and thus the curved mirror 18 would not be detached. Furthermore, the height adjusting mechanism is provided for each of the left and right ends of the curved mirror 18, and thus the angle of the curved mirror 18 can be adjusted as desired. With such an arrangement, even if the position of the projected image is shifted or its outer shape is distorted due to poor part accuracy or assembly accuracy, the projected image can still be adjusted closer to the normal position and shape by using the adjusting mechanism.

Furthermore, the reflection surface 18a of the curved mirror 18 is designed to be rotationally symmetrical around the optical axis 43 that runs coaxially with respect to the optical axis 42 of the projection lens 2. Thus, when manufacturing a molding die of the curved mirror 18, rotational processing can be performed around the optical axis 43, and thus the accuracy of the profile of the reflection surface 18a can be easily ensured. In addition, the boss 33 is arranged on the opposite side of the curved mirror 18 with respect to the protrusion 21 that serves as the rotation center and sandwiched between the opposing guides 34a and 34b having inner surfaces that are parallel to each other, and thereby the curved mirror 18 is prevented from being rotated in width direction. Thus, the projected image would not be shifted in width direction. In addition, the center axis 44 of the boss 33 is substantially parallel to the rotation axis 45 of the curved mirror 18 of the time of adjustment. Thus, when adjusting the angle of the curved mirror 18, the boss 33 moves up or down while rotating between the guides 34a and 34b, and thus the movement of the curved mirror 18 would not be interrupted.

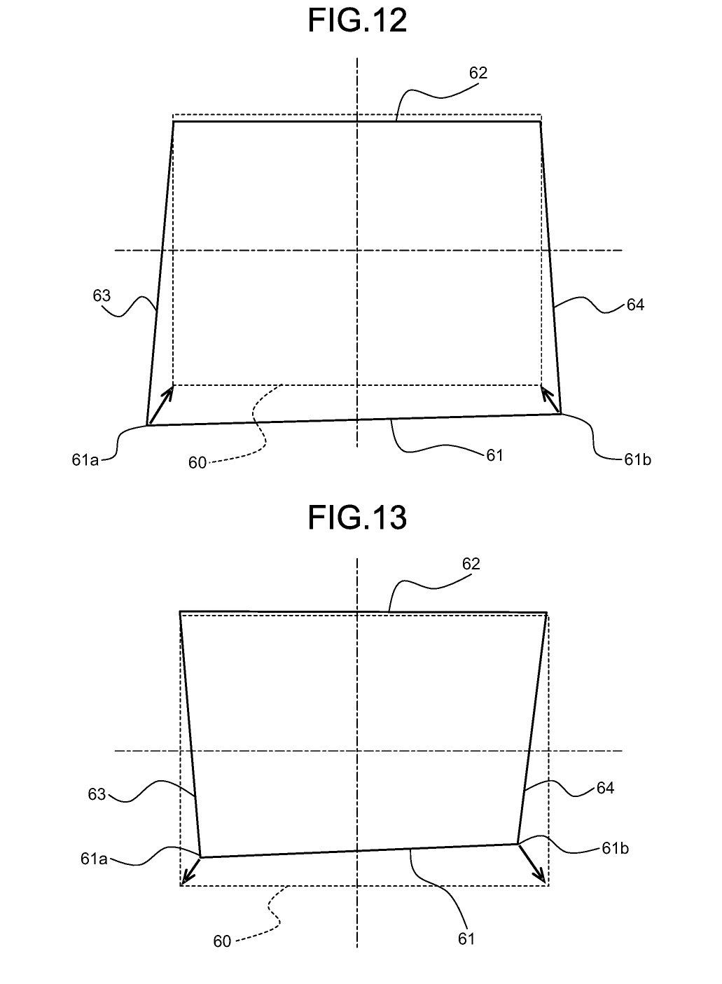

Next, the method of adjusting the projected image is explained. In FIGS. 12 and 13, the adjustment of the projected image whose bottom end 61 is shifted is described. A rectangular image projected on the screen 300 is viewed from the left of FIG. 3. In FIG. 12, with reference to a regular projected image position 60 indicated by a dotted rectangle, the bottom end 61 of the projected image is significantly shifted downward, and the left end 63 and the right end 64 of the projected image are tilted and make the image distorted. In the optical system according to the present embodiment, when the bottom end 61 of the projected image is shifted downward because of the tilt of the curved mirror 18, the top panel mirror 200, or the screen 300, the image is magnified and becomes a trapezoid with the bottom side wider than the top side. Furthermore, because the light beam that reaches the bottom end 61 of the projected image is sensitive to the tilt of the curved mirror 18, the top panel mirror 200, or the screen 300, the shift amount from the regular projected image position 60 is large. In contrast, the light beam that reaches the top end 62 of the projected image is less sensitive, and thus the shift amount of the top end 62 of the projected image is smaller than that of the bottom end 61.

To correct the position of the bottom left corner 61a of the projected image, the right adjustment screw 39b of the curved mirror 18 illustrated in FIG. 10 is loosened to lower the protrusion 28b so that the angle of the reflection surface 18a of the curved mirror 18 is changed, and the bottom left corner 61a of the projected image moves in the direction of the arrow. The light beam 40 traveling from the curved mirror 18 to the top panel mirror 200 crosses itself in the anteroposterior direction as well as in the left-right direction, and thus the light beam reflected on the right side of the curved mirror 18 is projected on the left side of the screen 300. For this reason, when the right adjustment screw 39b of the curved mirror 18 is turned around, the position of not the bottom right corner 61b but the bottom left corner 61a of the projected image is changed.

To correct the position of the bottom right corner 61b of the projected image, the left adjustment screw 39a of the curved mirror 18 illustrated in FIG. 9 is loosened to lower the protrusion 28a so that the angle of the reflection surface 18a of the curved mirror 18 is changed, and the bottom right corner 61b of the projected image is moved in the direction of the arrow. By loosening the adjustment screws 39a and 39b of the curved mirror 18, the bottom end 61 of the projected image is moved upward and the projected image is reduced. Thus, not only the position of the bottom end 61 of the projected image but also the tilt of the left end 63 and the right end 64 of the projected image can be corrected. Furthermore, as illustrated in FIG. 12, even when the bottom end 61 of the projected image is tilted, the positions of the bottom left corner 61a and the bottom right corner 61b of the projected image can be separately corrected by the adjusting mechanism provided independently for each of the left and right sides of the curved mirror 18.

The bottom end 61 of the projected image in FIG. 13 is shifted upward from the regular projected image position 60. The bottom end 61 of the projected image is shifted upward, and in addition, the left end 63 and the right end 64 of the projected image are tilted inwardly. The projected image is therefore distorted and becomes trapezoidal with the bottom side narrower than the top side. To correct the position of the bottom left corner 61a of the projected image, the adjustment screw 39b of FIG. 10 is tightened and the right protrusion 28b of the curved mirror 18 is raised to move the bottom left corner 61a of the projected image in the direction of the arrow. To correct the position of the bottom right corner 61b of the projected image, the adjustment screw 39a of FIG. 9 is tightened and the left protrusion 28a of the curved mirror 18 is raised to move the bottom right corner 61b of the projected image in the direction of the arrow. By tightening the adjustment screws 39a and 39b of the curved mirror 18, the bottom end 61 of the projected image is moved downward and enlarged. Thus, not only the position of the bottom end 61 of the projected image but also the tilt of the left end 63 and the right end 64 of the projected image can be corrected. As described above, with the adjusting mechanism provided on the left and right sides of the curved mirror 18, the shift of the bottom end 61 of the projected image and the distortion of the image that appears in accordance with the shift can be corrected.

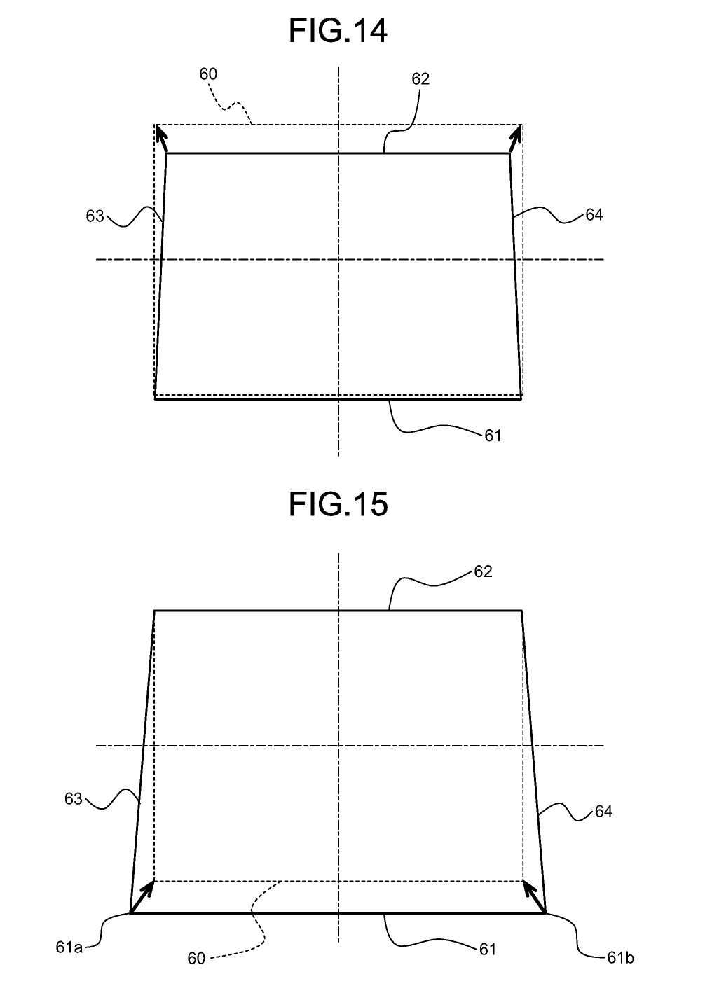

Next, the adjustment of the shifted top end 62 of the projected image is explained. In FIG. 14, the top end 62 of the projected image shifted downward from the regular projected image position 60 is illustrated. To correct the position of the top end 62 of the projected image, the adjustment screw 17 illustrated in FIG. 6 is loosened, and the flat mirror 4 is turned counterclockwise around the rotation axis 41. By turning the flat mirror 4 counterclockwise, the top end 62 of the projected image is moved upward. As a result, the top end 62 of the projected image is corrected to the regular position, but the bottom end 61 of the projected image is moved downward in accordance with the enlargement, as illustrated in FIG. 15. However, because this is the same situation as FIG. 12, correction can be made by adjusting the angle of the curved mirror 18. By loosening the adjustment screw 39b and the adjustment screw 39a of the adjusting mechanism of the curved mirror 18, the bottom left corner 61a and the bottom right corner 61b of the projected image are moved in the direction of the arrow. Here, the light beam that reaches the top end 62 of the projected image is barely moved because its sensitivity to the change of the angle of the curved mirror 18 is low.

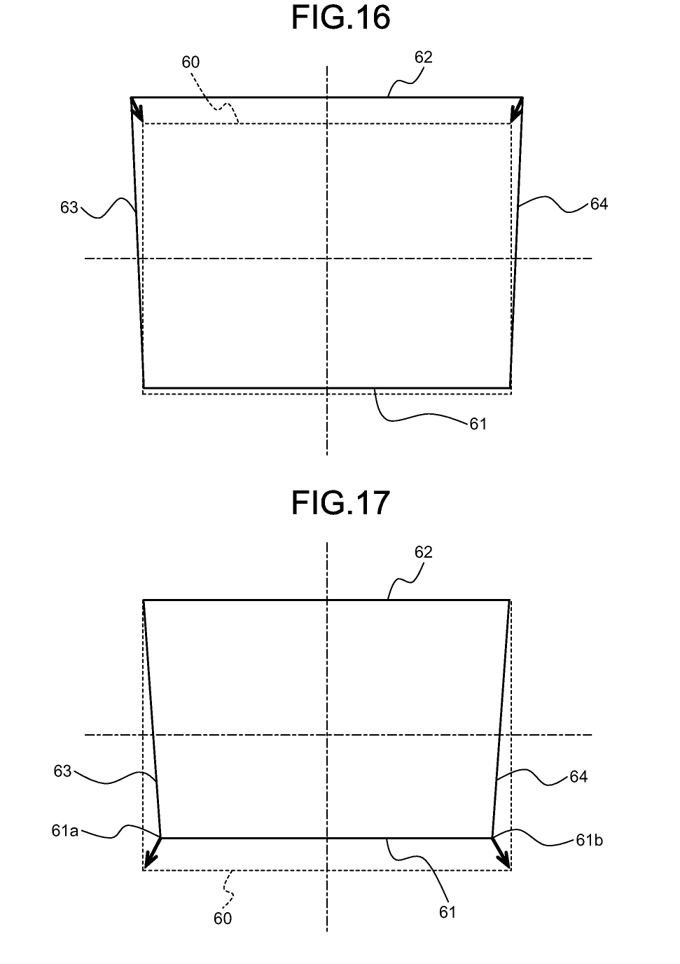

In FIG. 16, the top end 62 of the projected image shifted upward from the regular projected image position 60 is illustrated. To correct the position of the top end 62 of the projected image, the adjustment screw of FIG. 6 is tightened so that the flat mirror 4 is turned clockwise around the rotation axis 41. By turning the flat mirror 4 clockwise, the top end 62 of the projected image is moved downward. As a result, the top end 62 of the projected image is corrected to the normal position, but the bottom end 61 of the projected image is moved upward in accordance with scaling down, as illustrated in FIG. 17. However, because this is the same situation as FIG. 13, correction can be made by adjusting the angle of the curved mirror 18. By tightening the adjustment screw 39b and the adjustment screw 39a of the adjusting mechanism of the curved mirror 18, the bottom left corner 61a and the bottom right corner 61b of the projected image are moved in the direction of the arrow. As described above, by incorporating both the adjusting mechanism of the flat mirror 4 and the adjusting mechanism of the curved mirror 18, shift of the top end 62 of the projected image can be corrected.

### Second Embodiment

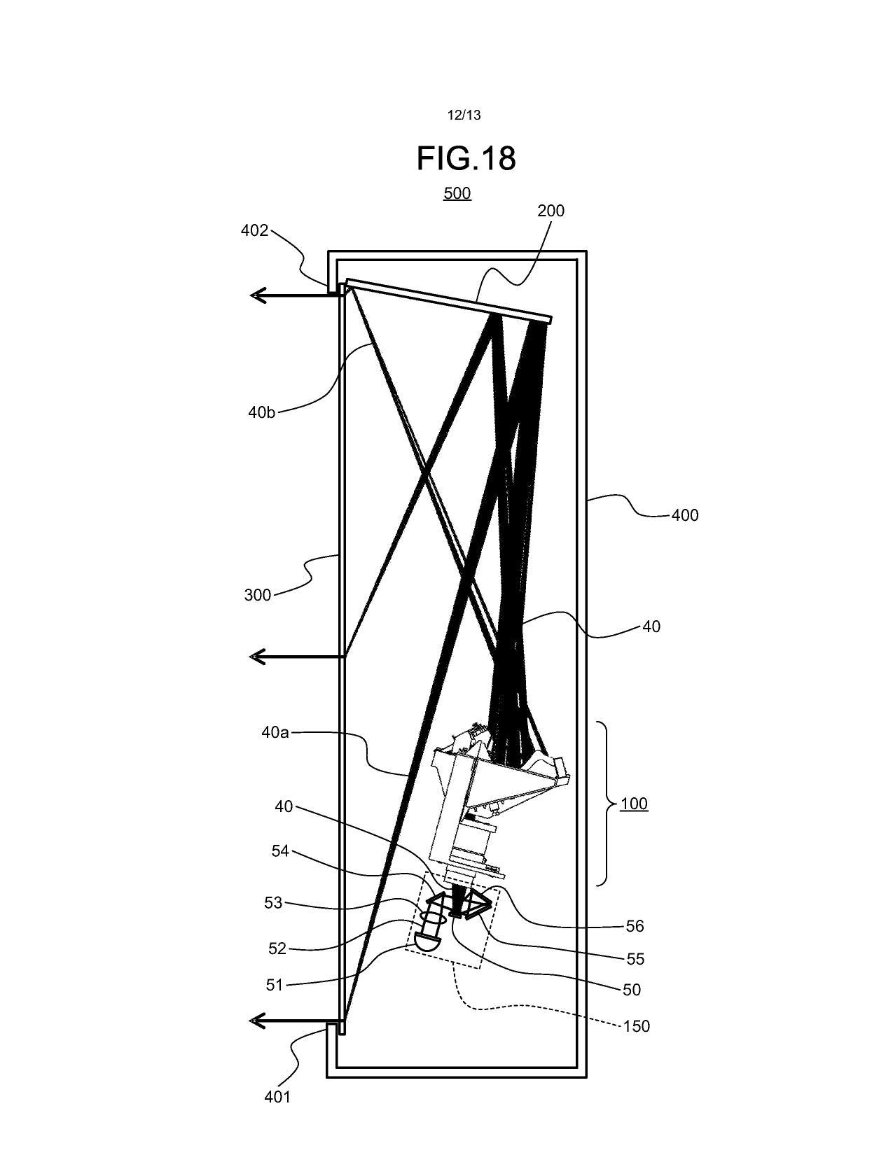

FIG. 18 is a diagram of the structure of an image projection device 500 incorporating the mirror adjusting mechanism according to the first embodiment of the present invention. The image projection device 500 is a rear projection television that projects the light beam 40 from the back side of the screen 300 and displays an image. It includes an optical illumination system 150 that is simplified in the drawing, the optical projection system 100 connected thereto, the top panel mirror 200 arranged above the optical projection system 100, the screen 300 arranged on the front surface of the image projection device 500 to present the image, and a housing 400 that contains the structural components.

A light beam 52 emitted from a lamp 51 that is a light source is gathered by a relay lens 53, and reflected from three mirrors 54, 55, and 56 so that the reflective light modulating device 50 such as a DMD can be illuminated. The light beam 40 reflected from the reflective light modulating device 50 is magnified by the optical projection system 100 discussed in the first embodiment and is upwardly directed. The upwardly directed light beam 40 is reflected from the top panel mirror 200 and projected onto the screen 300. As the light source of the optical illumination system 150, a light emitting diode (LED) or a laser element may be adopted in place of the lamp 51.

The incident surface of the screen 300 is formed into a Fresnel lens, with which the light beam 40 incident at an angle onto the screen 300 is bent and converted to a light beam in a horizontal direction (the direction orthogonal to the screen 300). Here, it is preferable that the light beam 40a to be projected onto the bottom end of the screen 300 is preferably output immediately above a rim 401 in the bottom of the housing 400, and that the light beam 40b to be projected on the top side of the screen 300 is preferably output immediately below a rim 402 in the top of the housing 400. If the light beams 40a and 40b are away from the rims 401 and 402, respectively, a blank portion is created outside the image when the image projection device 500 is viewed from the front (from the right side of FIG. 18), which makes the projected image look unattractive.

However, the positions of the screen 300 at which the light beam 40a and the light beam 40b are projected are often shifted from desired positions because of problems in the profile accuracy and installation positions of the optical components inside the optical projection system 100, an error in the installation angle of the top panel mirror 200, and the tilting of the screen 300. For example, if the projected position of the light beam 40b is shifted upward, the light beam 40b is blocked by the rim 402, which makes the image projected with its top portion missing. On the other hand, if the projected position is shifted downward, a blank portion is created between the light beam 40b and the rim 402, which makes the display look unattractive. Thus, the mirror adjusting mechanism according to the first embodiment is adopted in the optical projection system 100 so that the positions of the light beams 40a and 40b projected on the screen 300 can be adjusted.

As discussed above, by adopting the mirror adjusting mechanism according to the first embodiment in the optical projection system 100 of the image projection device 500, the positions of the light beams 40a and 40b projected on the screen 300 become adjustable. Hence, a rear projection television that favorably presents a projected image that is fully fit into the rims 401 and 402 of the housing 400, without any outer portion thereof missing, can be realized.

### Third Embodiment

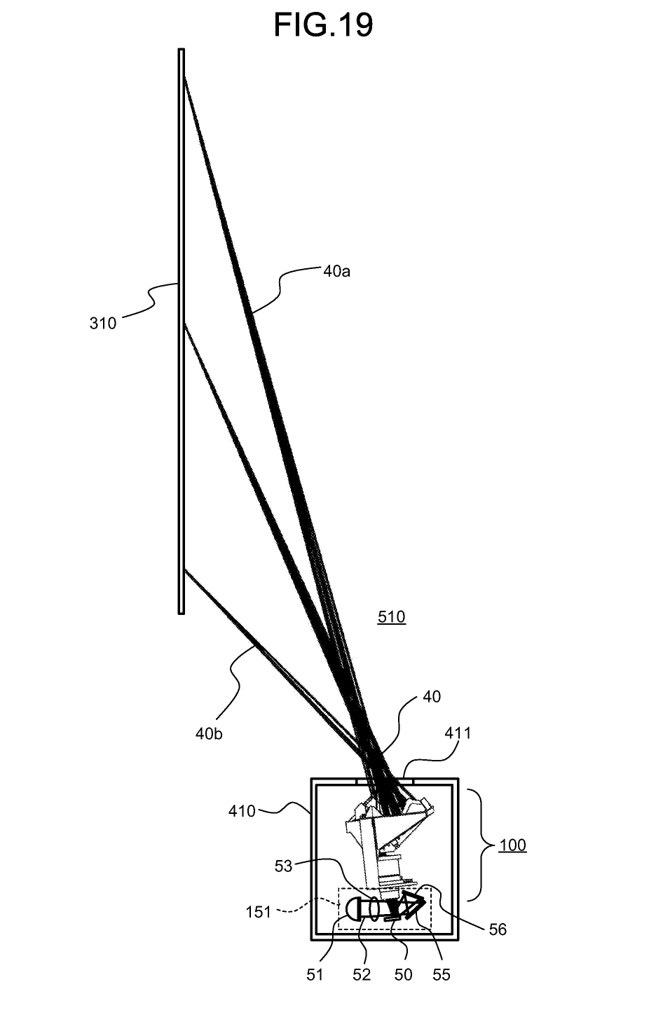

FIG. 19 is a diagram for showing the structure of an image projection device 510 incorporating the mirror adjusting mechanism according to the first embodiment of the present invention. The image projection device 510 is a front-type projector that projects the light beam 40 directly onto a screen 310 and displays an image. It includes an optical illumination system 151 that is simplified in the drawing, the optical projection system 100 connected thereto, the reflective screen 310 on which an image projected from the image projection device 510 is projected, a housing 410 that contains the structural components, and a window 411 in the top surface of the housing 410 through which the light beam 40 passes. According to the present embodiment, the top panel mirror 200 arranged in the structures of the first and second embodiments is not included, and the light beam 40 is projected from the optical projection system 100 directly onto the screen 310.

The light beam 52 emitted from the lamp 51 that is a light source is gathered by the relay lens 53, reflected from two mirrors 55 and 56 so that the reflective light modulating device 50 such as a DMD can be illuminated. The light beam reflected from the reflective light modulating device 50 is magnified by the optical projection system 100 discussed in the first embodiment and directed obliquely upward. The light beam 40 that is directed obliquely upward is projected onto the screen 310.

For the light source of the optical illumination system 151, a light emitting diode (LED) or a laser element may be adopted in place of the lamp 51. Furthermore, according to the present embodiment, the screen 310 is provided separately from the image projection device 510, but, for example, the image projection device 510 may be attached to a whiteboard or the like with brackets.

As discussed above, by adopting the mirror adjusting mechanism according to the first embodiment in the optical projection system 100 of the image projection device 510, the position and distortion of an image projected onto the screen 310 can be adjusted. Furthermore, the optical projection system 100 uses so-called “lens shift projecting method” in which the optical axis of the projection lens 2 is shifted with respect to the reflective light modulating device 50, and the light beam 40 is magnified and projected obliquely upward by the curved mirror 18. Thus, the image projection device 510 can be arranged close to the screen 310 and beneath the screen 300. For this reason, the image projection device 510 according to the present embodiment does not have to be placed on a desk or a table but may be placed directly on the floor, unlike a general front-type projector. Hence, the front-type projector that does not occupy the space on the desk or does not become obstructive can be realized.

Moreover, the light beam 40 in the image projection device 510 according to the present embodiment has an incident angle far larger with respect to the screen 310 than in a general front-type projector. In other words, the light beam 40 is projected obliquely upward onto the screen 310, and thus even if there is somebody standing in front of the screen 310, the light beam 40 would not be obstructed, and the projected image would not be in shadow.

According to the present invention, the shifted top and bottom ends of the projected image can be corrected, and the distortion of the projected image can also be corrected.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image projection device, comprising:
an optical illumination system that includes a light source;
a light modulation device that receives an image signal, and modulates a light beam emitted from the optical illumination system in accordance with the image signal; and
an optical projection system that magnifies and projects modulated light received from the light modulation device onto a screen for displaying an image,
wherein the optical projection system comprises:
a projection lens that is arranged with an optical axis thereof shifted with respect to the light modulation device in order to project the light beam obliquely onto the screen, and magnifies and projects the modulated light received from the light modulation device;
a flat mirror that reflects the light beam output from the projection lens, has a rotation center on a side thereof on which a light beam having a long path from the projection lens to the screen is reflected, rotates around the rotation center and adjusts an angle of the light beam; and
a curved mirror that reflects and magnifies the light beam received from the flat mirror, has a rotation center on a side thereof on which a light beam having a short path from the projection lens to the screen is reflected, rotates around the rotation center and adjusts the angle of the light beam.

2. The image projection device according to claim 1, wherein the rotation center of the flat mirror is a rotation axis parallel to the screen.

3. The image projection device according to claim 1, further comprising:
a holder for the flat mirror that holds the flat mirror;
first and second protrusions that are a pair of cylinders coaxially protruding from two sides of the holder for the flat mirror and serving as the rotation axis;
a base member that has V-shaped grooves into which the respective first and second protrusions are fitted; and
elastic members that urge the respective first and second protrusions in a direction of the V-shaped grooves.

4. The image projection device according to claim 3, further comprising:
an elastic member that is brought into contact with the holder for the flat mirror and urges the holder for the flat mirror in a rotational direction;
an adjustment screw that is brought into contact with the holder for the flat mirror or a component mounted on the holder for the flat mirror in a direction of stopping rotation of the holder for the flat mirror, wherein
an angle of the flat mirror is adjustable by turning the adjustment screw around.

5. The image projection device according to claim 1, wherein a reflection surface of the curved mirror is rotationally symmetrical with respect to the optical axis of the projection lens.

6. The image projection device according to claim 1, further comprising a holder for the curved mirror provided with a cone-shaped receiving portion, wherein
a first spherical protrusion arranged on the curved mirror and having a spherical tip is brought into contact with the receiving portion, and the curved mirror is supported by the holder for the curved mirror so as to rotate in all directions around the first spherical protrusion that serves as a pivot.

7. The image projection device according to claim 6, wherein
the curved mirror includes a second spherical protrusion and a third spherical protrusion that have spherical tips at symmetrical positions outside the reflection surface of the curved mirror on the side on which the light beam having the long path up to the screen is reflected, and
the angle of the curved mirror is adjustable around the rotation axis that passes a center of the pivot of the first spherical protrusion by adjusting heights of adjustment screws that are brought into contact with the tips of the second and the third spherical protrusions.

8. The image projection device according to claim 7, further comprising:
a third protrusion, a fourth protrusion, and a fifth protrusion arranged at positions on a back side of the curved mirror corresponding to respective positions of the first spherical protrusion, the second spherical protrusion, and the third spherical protrusion;
three elastic members corresponding to the third protrusion, the fourth protrusion, and the fifth protrusion arranged to urge the curved mirror against the holder for the curved mirror; and
three retaining members that press the elastic members down.

9. The image projection device according to claim 8, wherein a stroke of backward and forward movement of the third protrusion is shorter than a length of a portion of the first spherical protrusion inserted into the corresponding receiving portion.

10. The image projection device according to claim 7, further comprising:
a sixth protrusion that is arranged in center of an end portion of the curved mirror on an opposite side of the curved mirror with respect to the first spherical protrusion, in substantially parallel to a rotation axis that runs center of the first spherical protrusion, and has a cylindrical circumference of 180 degrees or greater in a circumferential direction; and
guides that nip the cylindrical circumference of the sixth protrusion in a left-right direction.
